(19) United States
(12) Patent Application Publication
(10) Pub. No.: US 2010/0037193 A1
(43) Pub. Date: Feb. 11, 2010

(54) METHOD OF CORRECTING PATTERN LAYOUT

(76) Inventor: Suigen KYOH, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/536,848

(22) Filed: Aug. 6, 2009

(30) Foreign Application Priority Data
Aug. 7, 2008 (JP) 2008-203936

(51) Int. Cl. G06F 17/50

(52) U.S. Cl. 716/6; 716/5; 716/19; 716/21

(57) ABSTRACT

A method of correcting a pattern layout includes: executing a process simulation under a plurality of conditions in which variations in a process parameter for forming a pattern corresponding to a design layout on a substrate are reflected, thereby estimating a plurality of finished patterns of the pattern; calculating dimensions of the plurality of the finished patterns; calculating a statistical amount from the calculated dimensions; comparing the statistical amount with a preset specification; calculating a correction amount when the specification is not satisfied; and correcting the design layout based on the calculated correction amount.

### CROSS REFERENCE TO RELATED APPLICATION

This application claims benefit of priority under 35 USC §119 to Japanese patent application No. 2008-203936, filed on Aug. 7, 2008, the contents of which are incorporated by reference herein.

### BACKGROUND OF THE INVENTION

1. Field of the Invention

The present invention relates to a method of correcting pattern layout

2. Related Background Art

As a size of a semiconductor device is becoming smaller, it is becoming difficult to form a pattern according to a design circuit on a substrate for a semiconductor device. For example, in a lithography process or the like, improvement of resolution of a usable exposure apparatus is behind development of microfabrication of a semiconductor device. As a result, quality of pattern transfer in the lithography process decreases. By using an exposure apparatus having low resolution, for example, minute variations in process parameters such as an exposure amount and a focus value further deteriorate a pattern shape. Particularly, a request for the shape of a gate pattern that operates a transistor in a semiconductor device is high, and management of the shape in the order of nanometer (nm) is necessary. Since a characteristic difference due to the difference between a design pattern as an ideal shape and a pattern actually formed on a wafer has reached an unignorable level, a method is proposed, of calculating a shape by performing a process simulation, obtaining a characteristic difference between a characteristic value of the calculated shape and a characteristic value of an ideal shape, and feeding back the characteristic difference to a stage of designing of a semiconductor device (for example, Wojtek J. Poppea, “From Poly Line to Transistor: Building BSIM Models for Non-Rectangular Transistors” SPIE Vol. 6156 26, 2006).

The method described in the above-mentioned document can output a characteristic difference caused by deterioration in shape but has a problem that deterioration in a transistor characteristic caused by deterioration in shape cannot be compensated.

### SUMMARY OF THE INVENTION

In accordance with a first aspect of the present invention, there is provided a method of correcting a pattern layout comprising:

executing a process simulation under a plurality of conditions in which variations in a process parameter for forming a pattern corresponding to a design layout on a substrate are reflected, thereby estimating a plurality of finished patterns of the pattern;

calculating dimensions of the plurality of the finished patterns;

calculating a statistical amount from the calculated dimensions;

comparing the statistical amount with a preset specification;

calculating a correction amount when the specification is not satisfied; and

correcting the design layout based on the calculated correction amount.

In accordance with a second aspect of the present invention, there is provided a method of correcting a pattern layout comprising:

executing a process simulation under a plurality of conditions in which variations in a process parameter for forming a pattern corresponding to a design layout of a device on a substrate are reflected, thereby estimating a plurality of finished patterns of the pattern;

calculating dimensions of the plurality of the finished patterns;

calculating a device characteristic value from the calculated dimensions;

calculating a statistical amount from the calculated device characteristic value;

comparing the statistical amount with a preset specification;

calculating a correction amount when the specification is not satisfied; and

correcting the design layout based on the calculated correction amount.

In accordance with a third aspect of the present invention, there is provided a method of correcting a pattern layout comprising:

from design data of a chip of a semiconductor device, sorting design pattern layouts to a first pattern layout belonging to a first region in a chip and a second pattern layout belonging to a second region, at least one of a specification or a device characteristic value of the second region being different from that of the first region;

performing a process simulation of the first pattern layout under a plurality of conditions in which variations in a process parameter are reflected and calculating a first finished shape of a pattern;

calculating a first dimension from the first finished shape;

obtaining a first device characteristic value under the plurality of conditions from the calculated first dimension;

calculating a first statistical amount from the obtained first device characteristic value;

comparing the first statistical amount with a preset first specification;

when the first specification is not satisfied, calculating a first correction amount;

correcting the first pattern layout based on the calculated first correction amount;

performing a process simulation of the second pattern layout under a plurality of conditions in which variations in a process parameter are reflected and calculating a second finished shape of a pattern;

calculating a second dimension from the second finished shape;

obtaining a second device characteristic value under the plurality of conditions from the calculated second dimension;

calculating a second statistical amount from the second device characteristic value obtained;

comparing the second statistical amount with a preset second specification;

when the second specification is not satisfied, calculating a second correction amount; and

correcting the second pattern layout based on the calculated second correction amount.

### BRIEF DESCRIPTION OF THE DRAWINGS

In the appended drawings:

FIG. 1 is a flowchart showing outline of processes in a first embodiment of a method of correcting a pattern layout in the present invention;

FIG. 2 is a histogram showing an example of variations in exposure amount and variations in focal position;

FIG. 3 shows an example of a simulation shape obtained under a condition of variations of process parameters;

FIGS. 4A and 4B are diagrams showing an example of a method of calculating gate length;

FIG. 5 shows an example of a distribution diagram of gate length obtained from a process simulation shape;

FIG. 6 is a diagram showing an example of a method of correcting gate dimension;

FIG. 7 is a diagram showing another example of the method of correcting gate dimension;

FIG. 8 is a diagram showing further another example of the method of correcting gate dimension;

FIG. 9 is a flowchart showing outline of processes in a second embodiment of a method of correcting a pattern layout of the present invention;

FIGS. 10A and 10B are diagrams for explaining an example of a method of calculating gate width;

FIG. 11 is a diagram showing an example of a method of correcting design data to set on-state current (Ion) to a target value;

FIG. 12 is a diagram showing another example of the method of correcting design data to set the on-state current (Ion) to a target value;

FIG. 13 is a diagram showing further another example of the method of correcting the design data to set the on-state current (Ion) to a target value; and

FIGS. 14 and 15 are explanatory diagrams of a third embodiment of a method of correcting a pattern layout in the present invention.

### DETAILED DESCRIPTION OF THE INVENTION

Since the present invention is particularly effective on a gate pattern for making a transistor operate, embodiments relating gate patterns will be described below with reference to the drawings. The present invention, however, is not limited to a transistor but can be applied to all of patterns for forming a semiconductor device. In the following diagrams, the same reference numeral is designated to the same part and repetitive description will be appropriately omitted.

### 1. First Embodiment

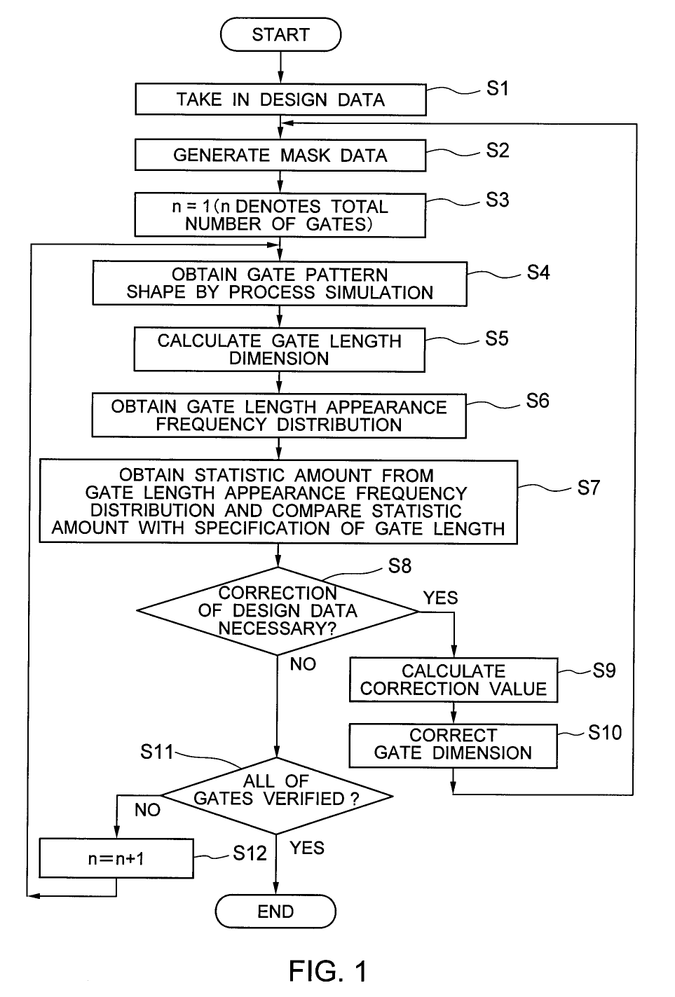

A process flow of a first embodiment is shown in the flowchart of FIG. 1. In FIG. 1, “n” expresses the total number of gates.

First, design data including a transistor pattern is taken in (step S1). By performing optical proximity correction or the like on the taken design data, mask data is generated (step S2).

Subsequently, n is set to “1” (n=1) (step S3), process simulation with the use of the generated mask data is performed under a plurality of conditions in which variations in the process parameter are reflected, and the shape of a gate pattern is obtained from the result of the process simulation (step S4). From the obtained pattern shape, the dimension of the gate length is calculated (step S5).

Next, an appearance frequency distribution of the gate length that determines the characteristic of a transistor is obtained (step S6).

A predetermined statistic amount is obtained from the obtained appearance frequency distribution. The statistic amount is compared with the specification of the gate length assigned to each transistor (step S7). When the statistic amount satisfies the specifications, the correction is unnecessary (step S8). When the specification is not satisfied, it is determined that the correction is necessary (step S8), a correction amount is calculated (step S9), the design data is corrected only by the correction amount (step S10), and the process flow is performed again (steps S2 to S8). More preferably, calculation of the correction amount is performed simultaneously with determination that correction is necessary.

The above-described verifying procedure is executed on all of gates (steps S11 and S12). Next, the process flow of the embodiment, mainly the processes in step S4 and steps S6 to S10 in FIG. 1, will be described more specifically.

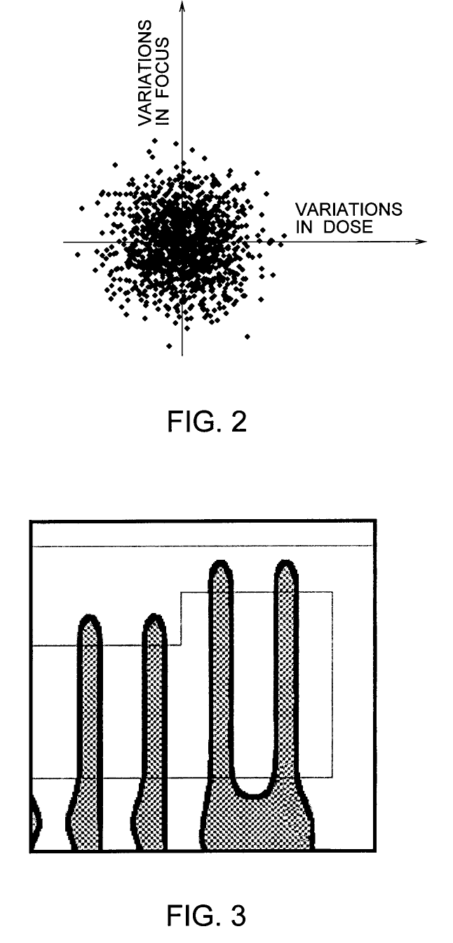

A process simulation performed in the process of step S4 is executed in a state where a process parameter in each process is deviated from an ideal value, that is, variations are given to the process parameters. The process parameters include, for example, exposure wavelength, exposure amount (dose), numerical aperture (NA) of a lens of an exposure apparatus, illumination shape (σ, ε) of the exposure apparatus, focal position (focus), phase and transmittance of a mask, and parameters of development and resist process and the like. In the embodiment, for example, variations are given to the exposure amount and the focal position in the lithography process. Variations are given on assumption that a deviation from an ideal value of a process parameter is independent of each other and is subject to a predetermined distribution. Dose variation is set to the horizontal axis of FIG. 2, focus variation is set to the vertical axis of FIG. 2, and the combination of the dose variation and the focus variation is plotted in FIG. 2. It is assumed that the appearance frequency of each of the variations is subject to the normal distribution. The value of the variation in each of the process parameters is thus determined and then, the process simulation is performed under a plurality of conditions in which variations are given to the process parameters. As a result, as shown in the example of the partial plan view of a gate in FIG. 3, a simulation shape can be obtained under each of the conditions in which variations in the process parameters are reflected.

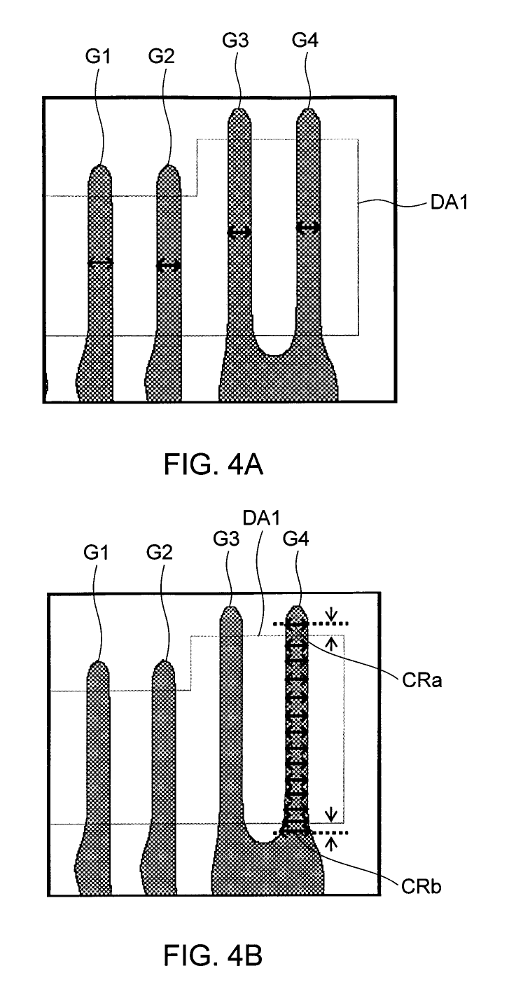

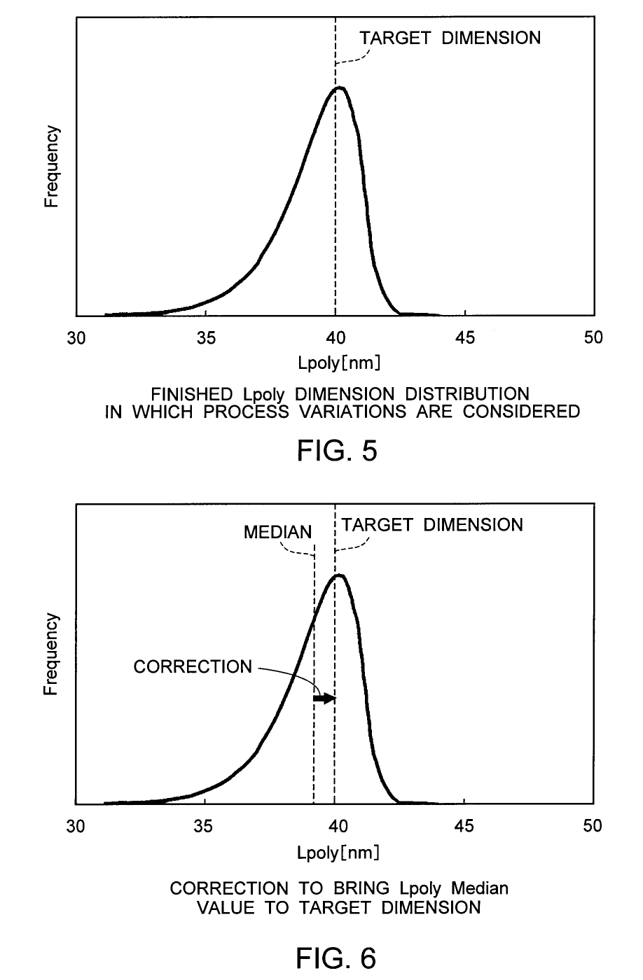

A process for obtaining the gate length appearance frequency distribution in step S6 in FIG. 1 will now be described. First, the gate length in the simulation shape obtained by the above-described step S2 is calculated. FIGS. 4A and 4B are diagrams for explaining an example of the gate length calculating method. For instance, in the example of FIG. 4A, in a region in which Gates G1 to G4 overlap a device area DA1 where a transistor becomes active, each gate length is calculated at the middle point between both ends in the gate direction (the gate extending direction), and a calculation value is used as a representative dimensional value of the gate. In the example shown in FIG. 4B, the gate length is measured a plurality of times in a range obtained by adding predetermined areas CRa and CRb to the device area DA1 in the gate length direction and, for example, an average value of measurement values is set as a representative gate length. In this example, the gate length is measured also in the areas CRa and CRb. By using such a method, the gate length of a finished transistor predicted from the process simulation shape is obtained. By performing such calculation of the gate length for every process condition, a gate length distribution as shown in FIG. 5 can be obtained. The horizontal axis expresses dimension of gate length Lpoly, and the vertical axis denotes appearance frequencies of the gate lengths. In FIG. 5, a gate length distribution for a transistor in which a target dimension of the gate length is 40 nm is shown.

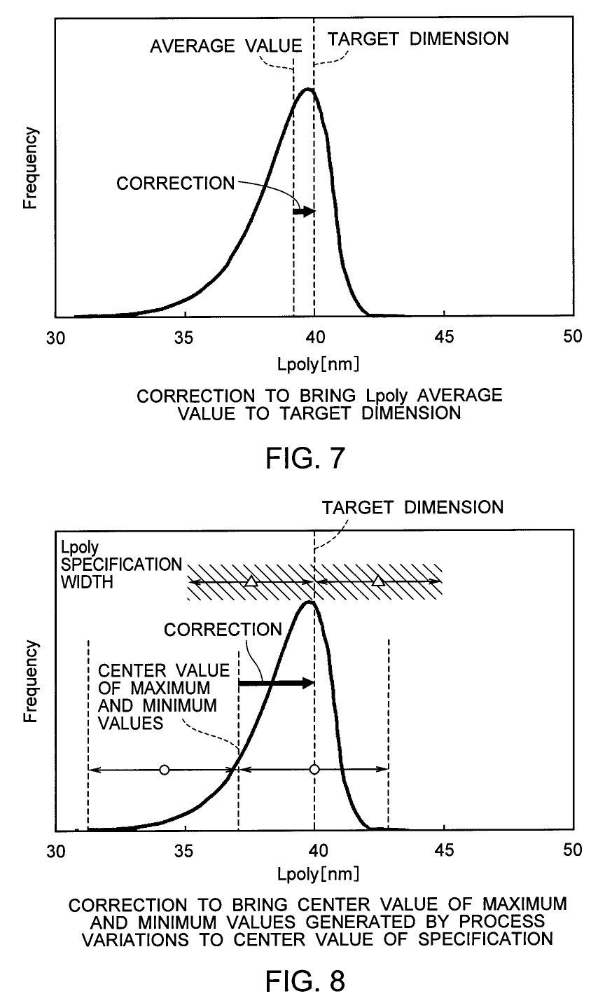

Subsequently, comparison with the specification of the gate length in step S7 in FIG. 1 will be described. When the gate length dimension distribution is obtained in step S6, the specifications of various gate lengths can be compared by using the statistical amounts. The specifications of the gate lengths are used in such a manner that, for example, the median value of the dimensional distribution matches the target value as shown in FIG. 6, an average value of the dimensional distribution matches the target value as shown in FIG. 7, and the center between the minimum and maximum values of the dimensional distribution matches the target value as shown in FIG. 8. The minimum and maximum values can be defined as values at which the probability that values become numerical values (gate length values) out of the range becomes a predetermined value or less. The specification of the gate length is not limited to the case where the statistical amount matches the target dimension but also to the case where the statistical amount falls within a predetermined range from the target dimension.

By comparing the difference between the statistical amount obtained from the distribution of appearance frequencies of the gate length and the target dimension, with the specification of the gate length, it is possible to determine whether the simulation results under the plurality of conditions in which variations in the process parameters are reflected satisfy the specification or not. The specification of the gate length is a predetermined value and, for example, is specified so that a deviation from the target dimension is 1.5% or less.

In steps S8 to S10 in FIG. 1, when it is determined from the comparison in the step S7 that the specification of the gate length is not satisfied, the design pattern of the transistor is corrected. The design data is corrected by the difference between the statistical amount obtained in the step S7 and the target dimension as the correction amount. For example, when the median value is smaller than the target value by 0.8 nm as shown in FIG. 6, by performing a correction to thicken the design data only by 0.8 nm, the median value and the target dimension can be matched with each other. In the case where the pattern correction amount does not always match a variation in the statistical amount, a value obtained by multiplying the difference between the statistical amount and the target dimension with a predetermined coefficient may be used as a correction amount.

The design data can be also corrected to eliminate the difference between the average value of the gate length distribution and the target dimension as shown in FIG. 7. Similarly, the design data can also be corrected to eliminate the difference between the middle point of the minimum and maximum values in the gate length distribution and the target dimension as shown in FIG. 8. In the case where it is not desired to directly correct the gate length of the design data, a method can be employed of, for example, adhering an identification figure according to a correction amount to the design data so as to surround the transistor and, at the time of returning again to the step S1 and generating mask data, generating mask data in consideration of a correction amount corresponding to the identification figure.

When the processes of the mask data generation (step S2), the process simulation (step S4), acquisition of the gate length distribution (steps S5 and S6), and comparison with the specification of the gate length (step S7) are repeatedly performed on the design data corrected as described above, and all of the transistor gates satisfy the specifications, the design data at that time is specified as final completed design data.

In the embodiment, the proper correction is performed on the design data so that a desired pattern can be always formed, a target pattern can be formed without being influenced by variations in the parameters of the processes. Thus, the probability of manufacturing a desired product increases and the yield improves.

### 2. Second Embodiment

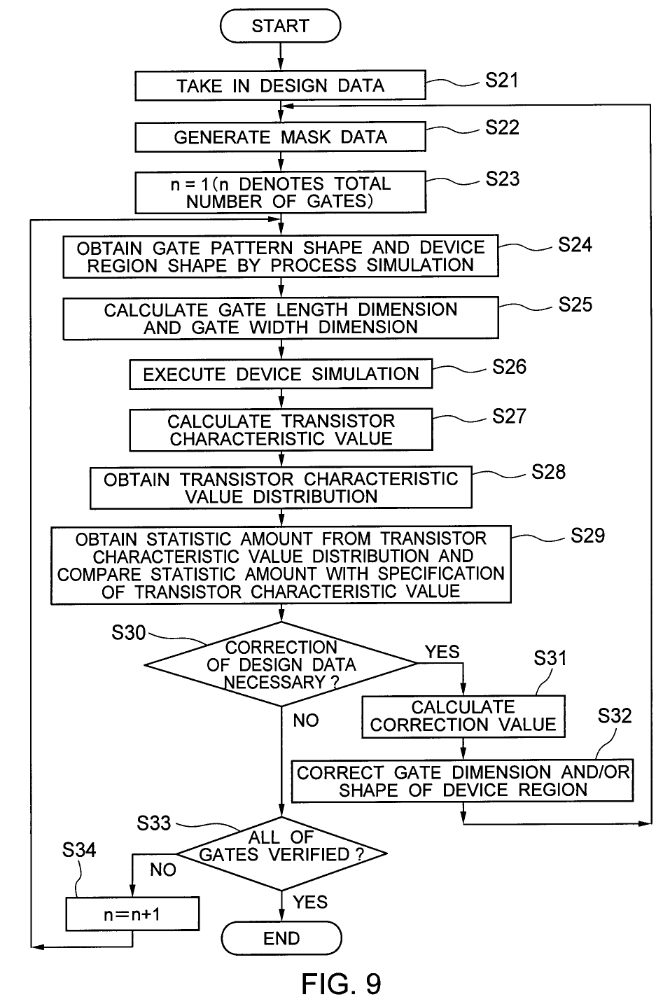

FIG. 9 is a flowchart showing outline of processes in a second embodiment of a method of correcting a pattern layout of the present invention. Steps S21 to S23 in FIG. 9 are substantially the same as the steps S1 to S3 in FIG. 1 and are obtained by simply adding 20 to the step numbers in FIG. 1, and the repetitive description will not be given. Description will be given from step S24.

First, process simulation is performed under a plurality of conditions in which variations in the process parameters are reflected using the mask data generated by the process of step S22, and the shape of the gate pattern and the shape of the device area are obtained from the result of the process simulation (step S24). Next, the gate length dimension is obtained transistor by transistor from the obtained pattern shape and the obtained device area shape and, in addition, the dimension of the gate width is also obtained by using the result of the process simulation (step S25). The point that the dimension of the gate width is also obtained is different from the first embodiment. It is to be noted that, in the specification, “dimensions of a pattern” are used as a concept including the gate length and the gate width.

Next, the device simulation is executed using two values of the gate length dimension and the gate width dimension (step S26), and the transistor characteristics under given conditions (in which variations in the process parameters are reflected) are calculated (step S27). In the device simulation, not only the two values of the gate length and the gate width but also, for example, the position of a contact hole, deposition of a stress liner, and the like may be also considered. A predetermined statistical amount is calculated from the characteristic value distribution and compared with the specification of a characteristic value of a transistor (step S29). In the case where the statistical amount satisfies the specification of the characteristic value, it is determined that correction of the transistor is unnecessary (step S30). In the case where the statistical amount does not satisfy the specification of the characteristic value, a correction value is calculated (step S31) and correction is performed on the design data (step S32) in order to satisfy the specification, and the processes are performed again from the generation of mask data (step S22).

After that, verification on other transistor gates is performed until all of the noted transistors in design data satisfy the specifications of characteristic values (steps S33 and S34), and the design data is specified as complete design data.

Next, the process flow of the embodiment, mainly, processes in step S24 and steps S26 to S32 in FIG. 9 will be described more specifically.

In the process simulation performed in step S24, different from the first embodiment in which the process simulation is performed only on the gate length, in the second embodiment, a simulation is executed under condition that process variations are reflected also in the device area to thereby obtain a finished shape of the device area. In the step S25 as well, in addition to calculation of the gate length dimension, the dimension of the gate width is also calculated.

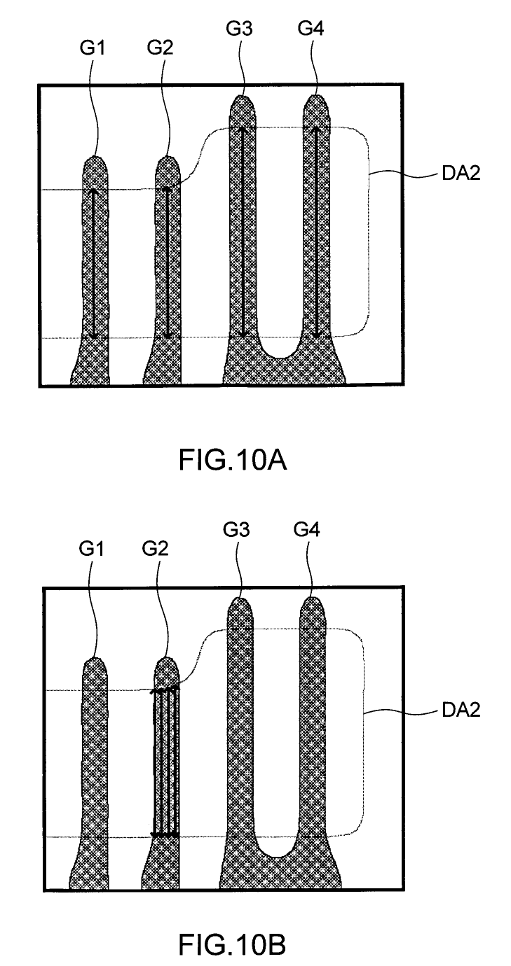

As a method of calculating the gate width, as shown in FIG. 10A, for example, in a manner similar to the example shown in FIG. 4A, in an area in which transistor gates G1 to G4 and a device area DA2 overlap each other, the length of each of the gate areas overlapping the device area is measured at the middle point between both ends in the gate length direction, and the result is used as a gate width.

There is a case that, like the transistor gate G2 which is the second one from the left in FIG. 10A, a transistor gate has a shape whose gate width changes at one of end portions. In order to take the influence of such a shape, for example, as shown in FIG. 10B, the gate width is calculated a plurality of times in the area where the gate G2 and the device area DA2 overlap each other and specifying the average value thereof as a representative gate width. Next, using the gate length and the gate width obtained as described above, a device simulation is executed (step S26). In the first embodiment, the gate length is obtained from the finished shape obtained by the process simulation. In the case of using the simulation results of the gate length and the gate width as inputs to the device simulation as in the second embodiment, they can be also used as they are.

Thus, the device simulation of the second embodiment is executed using a gate length and a gate width as inputs.

Next, using a result of the device simulation, a characteristic value of each transistor is calculated under the condition of the process variations in the transistor (in which variations of each process parameter are reflected) (step S27). The transistor characteristic value includes, for example, an on-state current (Ion) indicative of amount of current which flows when a transistor switch is turned on (On), an off-state current (Ioff) indicative of amount of current which leaks when a transistor switch is turned off (Off), and a threshold voltage (Vth) indicative of voltage at which an inversion layer is formed in a channel region in a transistor.

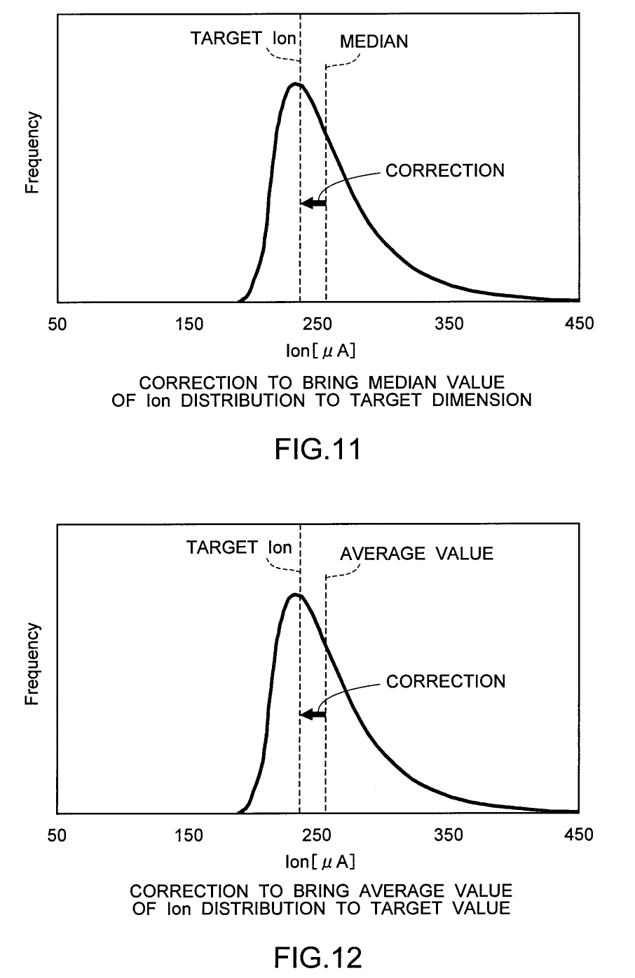

By obtaining the transistor characteristic value in the process of step S27 in FIG. 9 under a plurality of conditions in which variations of the process parameters are reflected, a distribution of the transistor characteristic values can be obtained (step S28). In the embodiment, paying attention to the on-state current (Ion), the following processes will be described. FIG. 11 shows the distribution of the on-state current (Ion) obtained in step S28. Due to variations of the process parameter, the gate shape and the shape of the device area change and, accordingly, the value of the on-state current (Ion) changes. From the distribution of the on-state current (Ion) obtained in such a manner, a median value as a statistical amount can be obtained.

The obtained median value of the on-state current (Ion) is compared with the specification of the transistor characteristic value (step S29 in FIG. 9). The specification of the characteristic value is a predetermined value which is specified, for example, in a manner that a deviation from a target on-state current (Ion) value is 5% or less. In the example shown in FIG. 11, the value of the target on-state current (Ion) is 235 μA/μm and, on the other hand, the median value is 260 μA/μm. A deviation amount in the specification of the transistor characteristic value is 5% or less and the characteristic value deviation of the noted transistor is 10%. From such a result, it is determined in step S30 that correction is necessary.

Subsequently, a correction amount is obtained so that the on-state current (Ion) of the transistor matches the target value (step S31), and the design data is corrected with the correction amount (step S32). In order to correct the on-state current (Ion) from 260 μA/μm to 235 μA/μm as the target value, for example, the gate length is increased by 0.8 nm, or the width of the device area is reduced by 10%. In this case as well, by preliminarily obtaining the degree of sensitivity of the characteristic value with respect to a deviation of the design value and storing it in a lookup table, the correction amount for the design data can be easily obtained from the deviation amount.

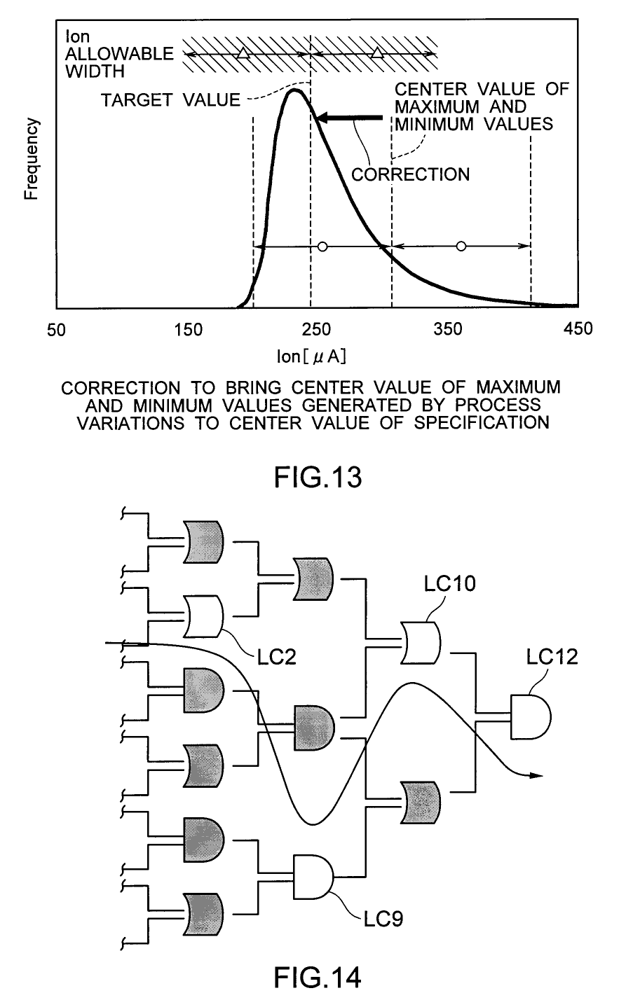

As shown in FIG. 12, design data can be corrected to eliminate the difference between an average value of the on-state current (Ion) characteristic values and the target value. Similarly, as shown in FIG. 13, design data can be corrected to eliminate the difference between the middle point of the maximum and minimum values in the characteristic value distribution and the target characteristic value. In the case where it is not desired to directly correct the gate length in the design data like the first embodiment, for example, there is a method of adhering an identification figure according to a correction amount to the design data so as to surround the transistor and, at the time of generating mask data again in step S22, generating mask data in consideration of the correction amount according to the identification figure.

The processes in steps S22 to S30 in FIG. 9 are repeated on the design data subjected to the correction as described above. When all of transistor gates satisfy the specifications (steps S33 and S34), the design data is specified as final completed design data.

### 3. Third Embodiment

In a third embodiment, the timing of each net is verified at the stage of designing a chip and a verification result is held in a database. At the time of generating mask data of a chip, a design pattern is corrected while switching from a device characteristic value to be noted to its specification in accordance with a degree of tightness in timing.

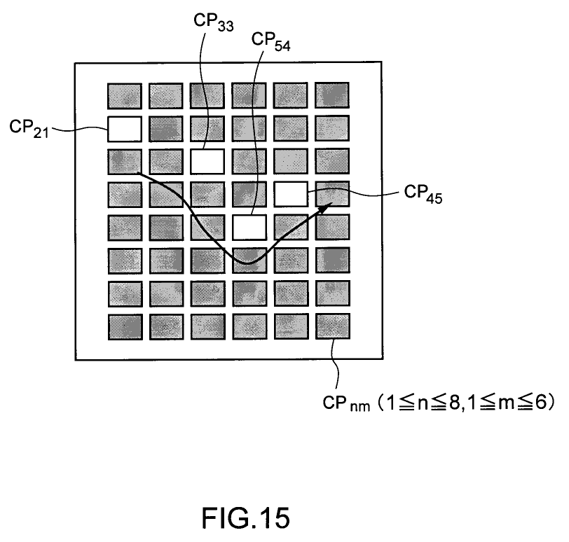

For example, for logic blocks as shown in FIG. 14, a block design pattern is generated by using a placement and routing tool or the like. The timing verification is then performed by an Static Timing Analysis (STA) tool. As a result of the verification, a signal line of a tight timing and a signal line of a not-so-tight timing can be discriminated from each other. In FIG. 14, logic circuits LC2, LC9, LC10 and LC12 on signal lines of tight timing are shown as blank blocks, and logic circuits LC1, LC3 to LC8, and LC11 on signal lines of not-so-tight timing are shown as solid blocks. When a chip is designed for the logic circuit blocks, a layout as shown in FIG. 15 is obtained. Each rectangular shape expresses a design cell pattern for realizing a logic circuit. Although not shown in FIG. 15, the design cell patterns are coupled to each other via metal wires. In a manner similar to FIG. 14, design cell patterns CP₂₁, CP₃₃, CP₄₅, and CP₅₄ of tight timing are shown as blank patterns. In the embodiment, the design cell patterns CP₂₁, CP₃₃, CP₄₅, and CP₅₄ correspond to, for example, a first pattern layout belonging to a first region, and the other design cell patterns correspond to, for example, a second pattern layout belonging to a second region.

After designing the chip of a semiconductor device in such a manner, design cells of tight timing and design cells of not-so-tight timing can be distinguished from each other. For example, for a transistor belonging to a net of tight timing, the on-state current (Ion) that specifies operation speed is selected as a transistor characteristic value. After that, in a manner similar to the foregoing embodiment, a process simulation is performed under a plurality of conditions in which variations in process parameters are reflected to calculate a finished shape. From the obtained finished shape, the value of an on-state current (Ion) under the plurality of conditions is obtained. From the obtained on-state current (Ion), a statistical value is calculated and compared with a specification. When the specification is not satisfied as a result of the comparison, a correction amount is calculated and the layout of a design cell pattern is corrected. Since a deviation of the on-state current (Ion) to a smaller value is not permitted, in the embodiment, the specification of the characteristic value is set as +0% to +10%, and the design cell patterns CP₂₁, CP₃₃, CP₄₅, and CP₅₄ are corrected. Similar processes are executed on the other design cell patterns. For a transistor belonging to a net of not-tight timing, the power consumption of an entire chip is decreased by decreasing leak current, therefore, with respect to the layout of the other design cell patterns, an off-state current (Ioff) is employed as a transistor characteristic value. A specification of a characteristic value is set, for example, to be −10% or less than a target value. In this embodiment, the on-state current (Ion) and the off-state current (Ioff) correspond to, for example, a first device characteristic value and a second device characteristic value, respectively. In addition, in this embodiment, finished shapes, dimensions, statistical amounts and correction amounts obtained with respect to the design cell patterns CP₂₁, CP₃₃, CP₄5, and CP₅₄ and the other patterns correspond to, for example, first and second finished shapes, first and second dimensions, first and second statistical amounts, and first and second correction amounts, respectively.

In the embodiment, in designing of a chip, a transistor characteristic value to be noted is changed and the specification of the characteristic value is also changed according to tightness of timing, thereby designing of a power-saving semiconductor device capable of operating at high speed can be realized.

### 4. Method of Manufacturing Semiconductor Device

When a semiconductor device is manufactured based on a layout generated by using the method of correcting a pattern layout described in the foregoing embodiments, a target pattern can be formed without being influenced by variations in process parameters. Consequently, the probability of manufacturing a desired produce increases. Thus, improvement in yield can be realized.

### 5. Program

The above-described series of processes of the method of correcting a pattern layout may be stored, as one or plural programs to be executed by a computer, in a recording medium such as a flexible disk or CD-ROM in the form of a recipe file, read by a computer such as an EWS, and executed. In such a manner, the method of correcting a pattern layout as explained above in the foregoing embodiments can be realized by using a general-purpose computer. The recording medium is not limited to a portable one such as a magnetic disk or an optical disk but may be a fixed one such as a hard disk drive or a memory. A program in which the above-described series of processes of the method of correcting a pattern layout is assembled may be distributed via a communication line (including a wireless communication) such as the Internet. Furthermore, a program in which the above-described series of processes of the method of correcting a pattern layout is assembled may be distributed in a state where it is encrypted, modulated, or compressed via a wired or wireless line such as the Internet or may be stored in a recording medium and distributed.

What is claimed is:

1. A method of correcting a pattern layout comprising:
executing a process simulation under a plurality of conditions in which variations in a process parameter for forming a pattern corresponding to a design layout on a substrate are reflected, thereby estimating a plurality of finished patterns of the pattern;
calculating dimensions of the plurality of the finished patterns;
calculating a statistical amount from the calculated dimensions;
comparing the statistical amount with a preset specification;
calculating a correction amount when the specification is not satisfied; and
correcting the design layout based on the calculated correction amount.

2. The method of claim 1,
wherein the statistical amount is any one of a median value of the calculated dimension, an average value of the calculated dimension, and a center between the minimum and maximum values of the calculated dimension.

3. The method of claim 1,
wherein variations in the process parameters are given on assumption that a deviation from an ideal value of a process parameter is independent of each other and is subject to a predetermined distribution.

4. The method of claim 1,
wherein the process parameters include exposure wavelength, exposure amount (dose), numerical aperture (NA) of a lens of an exposure apparatus, illumination shape (σ, ε) of the exposure apparatus, focal position (focus), phase and transmittance of a mask, and parameters of development and resist process.

5. The method of claim 1,
wherein the statistical amount falls within a predetermined range from the target dimension.

6. A method of correcting a pattern layout comprising:
executing a process simulation under a plurality of conditions in which variations in a process parameter for forming a pattern corresponding to a design layout of a device on a substrate are reflected, thereby estimating a plurality of finished patterns of the pattern;
calculating dimensions of the plurality of the finished patterns;
calculating a device characteristic value from the calculated dimensions;
calculating a statistical amount from the calculated device characteristic value;
comparing the statistical amount with a preset specification;
calculating a correction amount when the specification is not satisfied; and
correcting the design layout based on the calculated correction amount.

7. The method of claim 6,
wherein the device is a transistor, and
the device characteristic value includes an on-state current indicative of amount of current which flows when the transistor switch is turned on, an off-state current indicative of amount of current which leaks when the transistor switch is turned off, and a threshold voltage indicative of voltage at which an inversion layer is formed in a channel region in the transistor.

8. The method of claim 6,
wherein the process parameters include exposure wavelength, exposure amount (dose), numerical aperture (NA) of a lens of an exposure apparatus, illumination shape (σ, ε) of the exposure apparatus, focal position (focus), phase and transmittance of a mask, and parameters of development and resist process.

9. A method of correcting a pattern layout comprising:
from design data of a chip of a semiconductor device, sorting design pattern layouts to a first pattern layout belonging to a first region in a chip and a second pattern layout belonging to a second region, at least one of a specification or a device characteristic value of the second region being different from that of the first region;
performing a process simulation of the first pattern layout under a plurality of conditions in which variations in a process parameter are reflected and calculating a first finished shape of a pattern;
calculating a first dimension from the first finished shape;
obtaining a first device characteristic value under the plurality of conditions from the calculated first dimension;
calculating a first statistical amount from the obtained first device characteristic value;
comparing the first statistical amount with a preset first specification;
when the first specification is not satisfied, calculating a first correction amount;
correcting the first pattern layout based on the calculated first correction amount;
performing a process simulation of the second pattern layout under a plurality of conditions in which variations in a process parameter are reflected and calculating a second finished shape of a pattern;
calculating a second dimension from the second finished shape;
obtaining a second device characteristic value under the plurality of conditions from the calculated second dimension;
calculating a second statistical amount from the second device characteristic value obtained;
comparing the second statistical amount with a preset second specification;
when the second specification is not satisfied, calculating a second correction amount; and
correcting the second pattern layout based on the calculated second correction amount.

10. The method of claim 9,
wherein the first and second regions are determined according to a degree of tightness in timing.

11. The method of claim 9,
wherein the device is a transistor, and
the first and second device characteristic values include on-state currents indicative of amounts of currents which flow when the transistor switch is turned on, and off-state currents indicative of amounts of currents which leak when the transistor switch is turned off.

12. The method of claim 9,
wherein the process parameters include exposure wavelength, exposure amount (dose), numerical aperture (NA) of a lens of an exposure apparatus, illumination shape (σ, ε) of the exposure apparatus, focal position (focus), phase and transmittance of a mask, and parameters of development and resist process.
